(19) United States
(12) Patent Application Publication
(10) Pub. No.: US 2025/0023198 A1
(43) Pub. Date: Jan. 16, 2025

(54) BUS BAR PROTECTIVE COVER AND METHOD OF CONSTRUCTION THEREOF

(71) Applicant: FEDERAL-MOGUL POWERTRAIN LLC, Northville, MI (US)

(72) Inventors: Xiaodan Qiu, Phoenixville, PA (US); Jordan Zachary Boatwright, York, PA (US); Philip Marks, Chester Springs, PA (US); Cassie Malloy, Trappe, PA (US)

(21) Appl. No.: 18/712,702

(22) PCT Filed: Nov. 30, 2022
(86) PCT No.: PCT/US2022/080622

§ 371 Date: May 23, 2024

Related U.S. Application Data
(60) Provisional application No. 63/284,009, filed on Nov. 30, 2021.

(51) Int. Cl. H01M 50/503; H01M 50/505; H01M 50/522; H01M 50/524

(52) U.S. Cl. CPC H01M 50/503; H01M 50/505; H01M 50/522; H01M 50/524; H01M 2220/20

(57) ABSTRACT

A cover for providing protection to a bus bar used to interconnect cells of a battery of an electric vehicle, and method of construction thereof, is provided. The cover includes an impervious layer, an adhesive layer, and a fabric wall sandwiched between the impervious layer and the adhesive layer. The adhesive layer is provided to facilitate quick and easy attachment of the cover to a desired portion of the bus bar, wherein the cover can be shaped to cover any desired area of the bus bar in a conforming fit about the selected portion or entirety of the bus bar.

### CROSS-REFERENCE TO RELATED APPLICATION

This application claims the benefit of U.S. Provisional Application Ser. No. 63/284,009, filed Nov. 30, 2021, which is incorporated herein by reference in its entirety.

### BACKGROUND OF THE INVENTION

### 1. Technical Field

This invention relates generally to protective covers for protecting an elongate member contained therein, and more particularly to fire suppressing dielectric protective covers for elongate members of electric vehicle battery packs.

### 2. Related Art

It is known to contain elongate members, such as bus bars of electric vehicle battery packs, in circumferentially continuous, tubular walled sleeves to provide protection to the elongate members against impact and abrasion, fluid and external thermal affects. However, the continuous tubular walled sleeves can prove difficult to assemble, particularly over connectors, and have a thick wall, thereby being inflexible and occupying valuable space in design. There remains a need for protective covering that can provide dielectric, fire suppressant protection to an elongate member contained therein, while also being flexible and able to attain a low profile, having a conformed fit about the elongate member and connectors thereof so as to not be cumbersome, unsightly and bulky. There is a further need to have a protective cover that is able to protect a bus bar connection between cells of a battery of an electric vehicle battery system to enable the vehicle to remain drivable under power from the battery system for at least 5 minutes after a thermal runaway condition of one or more of the cells of the battery to enable a driver of the electric vehicle ample time to safely maneuver to a suitable parking location and vacate the vehicle.

### SUMMARY OF THE INVENTION

One object of the disclosure is to provide a cover that provides dielectric, fire suppressant protection to an elongate member covered thereby.

Another object of the disclosure is to provide protection to a bus bar connection between cells of a battery of an electric vehicle battery system to enable a driver of the electric vehicle ample time to safely maneuver to a suitable parking location and vacate the vehicle.

Another object of the disclosure is to provide protection to a bus bar connection between cells of a battery of an electric vehicle battery system via an adhesive cover (patch) to enable the battery system to supply power to the electric vehicle for 5 minutes or more.

Another object of the disclosure is to provide a cover, also referred to as patch, for self-adhesion to a bus bar for forming a connection between cells of a battery of an electric vehicle battery system, such that the cover conforms about and protects at least a portion of the bus bar.

In accordance these and other objects, a cover, also referred to as patch, for providing protection to a bus bar used to interconnect cells of a battery of an electric vehicle is provided. The cover includes a fabric wall having made of flame-resistant material: an impervious layer attached to the fabric wall; and an adhesive layer attached to the fabric wall, wherein the fabric wall is sandwiched between the impervious layer and the adhesive layer. The adhesive layer is provided to facilitate quick and easy attachment of the cover to a desired portion or entirety of the bus bar, wherein the cover can be shaped to cover any desired area of the bus bar in a conforming fit about the selected portion or entirety of the bus bar.

In accordance with another aspect of the disclosure, the fabric wall can be fabricated with interlaced flame-resistant multifilament yarn.

In accordance with another aspect of the disclosure, the flame-resistant multifilament yarn is a mineral yarn.

In accordance with another aspect of the disclosure, the mineral yarn includes at least one of fiberglass yarn, silica yarn, and basalt yarn.

In accordance with another aspect of the disclosure, the interlaced yarn is one of a woven, braided and knit structure.

In accordance with another aspect of the disclosure, the impervious layer can be one of a silicone, silicone-based, mica-based, liquid silicone rubber, polytetrafluoroethylene, or polyurethane layer bonded directly to the fabric wall.

In accordance with another aspect of the disclosure, the impervious layer can be provided as a liquid or powder mixture coated on the fabric wall.

In accordance with another aspect of the disclosure, the impervious layer can be a solid sheet of material laminated to the fabric wall with an intermediate flame-resistant adhesive layer.

In accordance with another aspect of the disclosure, the adhesive layer can be a self-adhesive layer configured to be selectively exposed for adhesion to the elongate member.

In accordance with another aspect of the disclosure, the fabric wall, the impervious layer, and the adhesive layer can be shaped to form a pre-shaped patch configured to be fixedly attached in a conformed fit to the elongate member by adhesion of the adhesive layer to the bus bar.

In accordance with another aspect of the disclosure, a release film can be attached to the adhesive layer, with the release film being selectively removable from the adhesive layer to expose the adhesive layer for adhesion to the bus bar.

In accordance with another aspect of the disclosure, a cover for protecting a bus bar for forming a connection between cells of a battery of an electric vehicle includes: a fabric wall having made of flame-resistant material: an impervious layer attached to the fabric wall; and an adhesive layer attached to the fabric wall, wherein the fabric wall is sandwiched between the impervious layer and the adhesive layer.

In accordance with another aspect of the disclosure, a method of constructing a cover for providing flame-resistant, dielectric protection to a bus bar for interconnecting cells of a battery of an electric vehicle includes: forming a fabric wall having made of flame-resistant material: attaching an impervious layer to the fabric wall; and attaching an adhesive layer to the fabric wall such that the fabric wall is sandwiched between the impervious layer and the adhesive layer, and the adhesive layer is oriented to be fixed to the bus bar.

In accordance with another aspect of the disclosure, the method can further include attaching a release film to the adhesive layer with the release film being selectively removable from the adhesive layer to expose the adhesive layer for adhesion to the bus bar.

In accordance with another aspect of the disclosure, the method can further include providing the impervious layer being one of a silicone, silicone-based, mica-based, liquid silicone rubber, polytetrafluoroethylene, or polyurethane layer.

In accordance with another aspect of the disclosure, the method can further include forming the impervious layer from a liquid or powder mixture coated on the fabric wall.

In accordance with another aspect of the disclosure, the method can further include forming the impervious layer from a solid sheet of material laminated to the fabric wall with an intermediate adhesive layer.

In accordance with another aspect of the disclosure, the method can further include forming the fabric wall by interlacing flame-resistant multifilament yarn together.

In accordance with another aspect of the disclosure, the method can further include providing the flame-resistant multifilament yarn as a mineral yarn.

In accordance with another aspect of the disclosure, the method can further include providing the mineral yarn including at least one of fiberglass yarn, silica yarn, and basalt yarn.

In accordance with another aspect of the disclosure, the method can further include interlacing the flame-resistant multifilament yarn via one of a weaving, braiding and knitting process.

In accordance with another aspect of the disclosure, the method can further include forming the fabric wall in a non-woven process to provide the fabric wall as a non-woven layer.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a perspective view of a motor vehicle having a cover constructed in accordance with one aspect of the disclosure fixed to a bus bar of an electric vehicle battery;

FIG. 2 is a schematic plan view of a bus bar to be protected with a pair of covers shown prior to attachment to the bus bar:

FIG. 2A is a cross-sectional view taken generally along the line 2A-2A of FIG. 2:

FIG. 2B is a view similar to FIG. 2A of a cover constructed in accordance with another aspect of the disclosure:

FIG. 3 is an assembled view of the covers on the bus bar of FIG. 2;

FIG. 3A is a cross-sectional end view taken generally along the line 3A-3A of FIG. 3:

FIG. 3B is a view similar to FIG. 3A of a cover constructed and applied to the bus bar in accordance with another aspect of the disclosure;

FIG. 4 is a view similar to FIG. 3 illustrating a pair of covers in accordance with another aspect of the disclosure on the bus bar of FIG. 2; and

FIG. 4A is a cross-sectional end view taken generally along the line 4A-4A of FIG. 4.

### DETAILED DESCRIPTION OF PREFERRED EMBODIMENTS

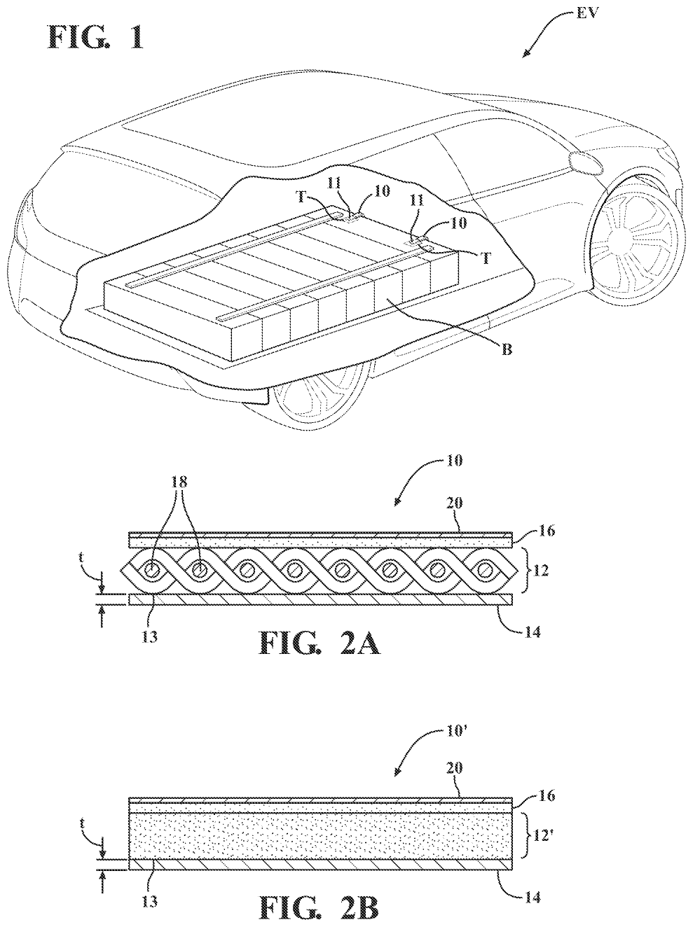

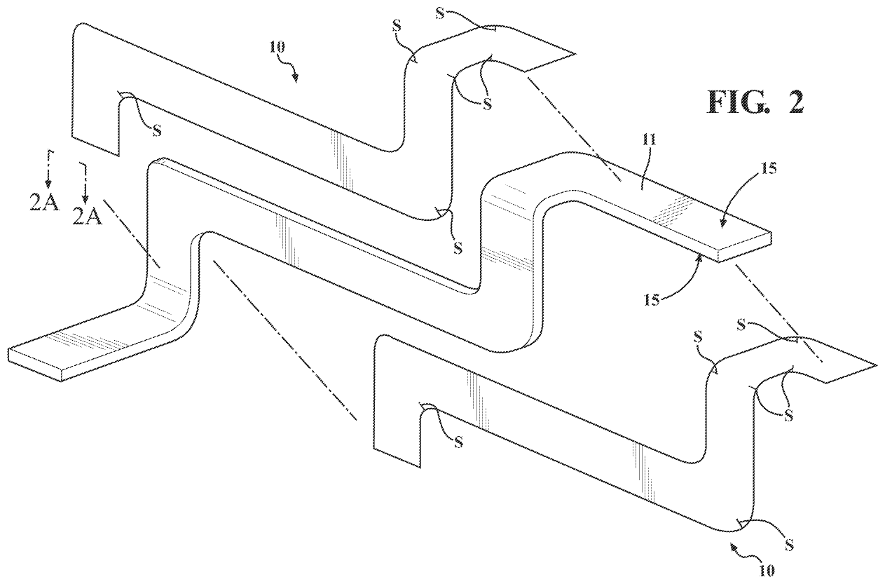

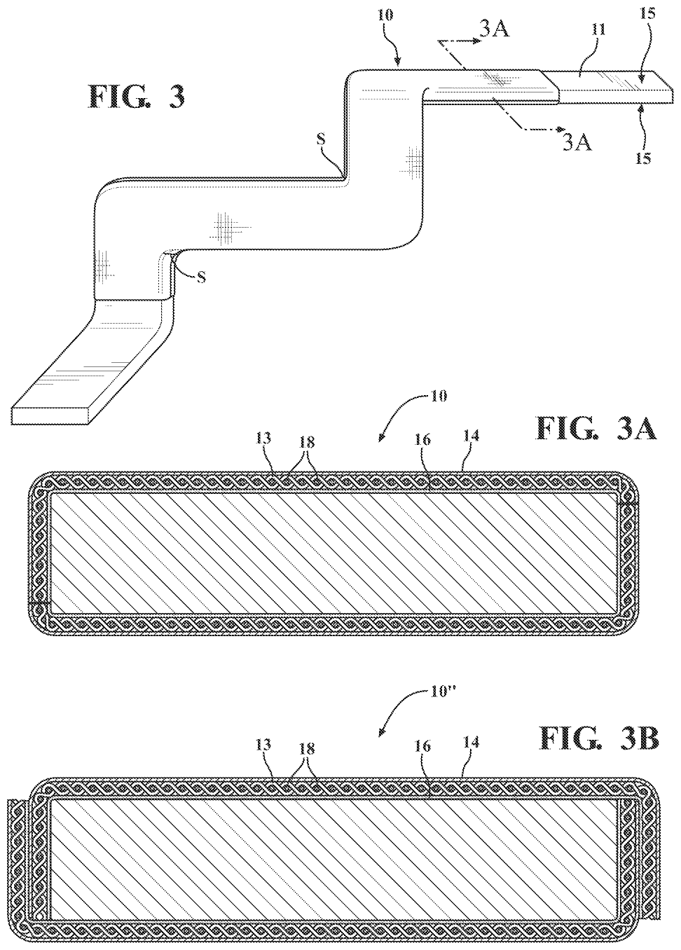

Referring in more detail to the drawings, FIG. 1 illustrates a highly flexible, protective cover, referred to hereafter as patch 10, constructed in accordance with one aspect of the invention having a laminated structure, as best shown in FIG. 2A, including a fabric wall 12 made of flame-resistant material: an impervious layer 14 attached to an outwardly facing side of the fabric wall 12, and an adhesive layer 16 attached to an inwardly facing side of the fabric wall 12. Accordingly, the fabric wall 12 is sandwiched between the outermost impervious layer 14 and the innermost adhesive layer 16. The patch 10 can be applied as a single member (single lamination of the aforementioned layers), or the patch 10 can be applied as a plurality of members (including multiple laminations of the aforementioned layers), shown as a pair of patches 10, configured for attachment in mirrored relation with one another via the adhesive layer 16, to an elongate member 11 to be protected, such as a bus bar interconnecting adjacent cells of a battery pack B of a vehicle, such as an electric vehicle EV, to one another. Accordingly, one patch 10 can be applied to one side 15 of the bus bar 11, while the other patch 10 can be applied to an opposite side 15 of the bus bar 11. This has been found particularly useful to cover non-straight bus bars 11 having bends, such as 90 degree bends, by way of example and without limitation, wherein the opposite patches 10, also referred to as bus bar covers, can be provided having mirrored shapes with one another to cover the non-straight bus bar 11 without having to bend or otherwise deform the separate patches 10 substantially, thereby avoiding the formation of wrinkles, while providing conforming, close-fitting protective covers about the bus bar 11. It is to be recognized that opposite edges of the patches 10 can be brought into a butt joint (FIG. 3A) with one another or overlap one another (FIG. 3B) so as to cover the entirety of the outer circumference of the bus bar. Accordingly, the patch(es) 10 provide uniform protection to and about the bus bar 11 against impact forces, such as may be experienced in a vehicle crash, abrasion, and ingress of contamination, by way of example and without limitation, and wherein the patch(es) 10, in addition to providing impact protection, suppresses flame propagation, such as in the event of thermal runaway of one or more of the cells of the battery pack B, thereby allowing the electric vehicle EV to remain powered by the battery B for 5 minutes or more to allow the electric vehicle EV to be safely driven to a parked location, whereat the operator can evacuate the electric vehicle EV.

The fabric wall 12 can be fabricated with interlaced flame-resistant multifilament yarn 18. The flame-resistant multifilament yarn 18 can be provided, in part or in entirety, as a mineral yarn, wherein the mineral yarn can include at least one of fiberglass yarn, silica yarn, and basalt yarn. The multifilament yarn 18 can be provided as a plurality of separate yarns interlaced with one another in a weaving, braiding or knitting process to provide the fabric wall 12 having a resulting woven, braided or knit structure. In accordance with another aspect of the disclosure, the fabric wall 12 can be fabricated as a flame-resistant non-woven layer (FIG. 2B), such as in an airlaying or carding process, by way of example and without limitation.

The impervious layer 14 is provided to prevent the ingress, absorption, penetration and passage of fluid, dust, particles, smoke into and through the fabric wall 12, and to enhance the flame resistance and enhance flame protection of the patch 10. The impervious layer 14 can be provided to be stretchable in all directions, including the lengthwise and radial directions, to allow the underlying fabric wall 12 to remain stretchable along the lengthwise and radial directions, and can be provided being elastically resilient, thereby facilitating the formation of a wrinkle-free, snug conforming fit of the fabric wall 12, and ultimately the patch 10, on and about the bus-bar 11.

Upon being exposed to an extreme heat scenario, such as during an unintended thermal runaway condition within one or more cells of the battery pack B, by way of example and without limitation, the flame-resistant multifilament yarns 18 retain their structural integrity, due to the synergies provided between the layers 14, 16, 18, to suppress flame growth and propagation for at least 5 minutes or more, thereby allowing ample time for an occupant of the motor vehicle EV to park and/or evacuate the motor vehicle EV.

The impervious layer 14, such as a silicone, silicone-based, liquid silicone rubber, mica-based, polytetrafluoroethylene, or polyurethane layer, can be applied and bonded to an outer surface 13 of the fabric wall 12, with the impervious layer 14 being bonded directly to the outer surface 13. The impervious layer 14 can be applied to the outer surface 13 using any desired process that allows the desired thickness (t: FIG. 2A) of the impervious layer 14 to be attained. In the exemplary embodiment, the thickness t is between about 0.05 and 3 mm, and more preferably between about 0.1 and 0.3 mm. When the impervious layer 14 is provided within the aforementioned range of thickness t, the flexibility and conformability of the fabric wall 12 is unaffected or substantially unaffected (thereby allowing the fabric wall 12 to retain a flexibility and conformability as though no impervious layer were bonded thereto), and optimal dielectric strength is provided to the patch 10, which can provide a dielectric breakdown voltage between about 5 to 40 kV. Accordingly, the elongate member 11 is protected against unwanted electrical interference, including electromagnetic interference (EMI), radiofrequency interference (RFI), and electrostatic discharge (ESD). In addition to the various electrical protections, greatly enhanced protection to the elongate member 11 against impact forces can be provided as a result of including the impervious layer 14. Further yet, enhanced protection against the ingress of contamination is provided, such as to fluid, gas and solid debris, given the impervious layer 14 can be hydrophobic and impervious to fluid, gas and solid debris.

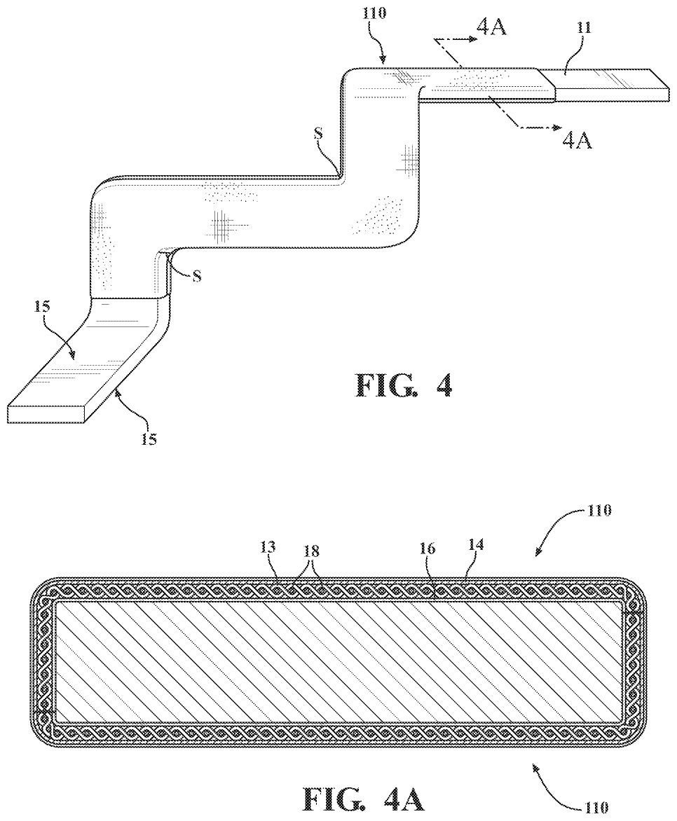

The impervious layer 14 can be provided as a liquid or powder mixture coated and bonded on the outer surface 13 of the fabric wall 12. In accordance with another aspect of the disclosure, as shown in FIGS. 4 and 4A, a patch or patches 110 can be provided with the impervious layer 14 as a solid sheet of material that is subsequently laminated to the outer surface 13 of the fabric wall 12 with an intermediate flame-resistant adhesive layer.

The adhesive layer 16 can be a self-adhesive layer, such as a pressure-sensitive adhesive (PSA), configured to be selectively exposed via selective removal of a release film 20 (FIGS. 2A and 2B) for adhesion of the self-adhesive layer 16 directly to the elongate member 11. The fabric wall 12, the impervious layer 14, and the adhesive layer 16 can be shaped as desired, having the same or substantially the same shape as the opposite sides 15 of the bus bar 11, to form the pre-shaped patch 10 to be fixedly attached in a conformed fit to the bus bar 11 by adhesion of the adhesive layer 16 to the bus bar 11. The pre-formed patch 10 can be configured to be wrapped about a portion or the entirety of the circumference of the elongate member 11, or the pre-shaped patch 10 can be applied as separate pieces to separate surfaces, such as to separate planar sides 15, also referred to as outer face surfaces, of the elongate member 11. To facilitate a smooth, non-wrinkled appearance, slits S can be strategically formed along opposite edges of the patches 10, 110 to allow edges of the patches 10, 100 to be folded over opposite edges of the bus bar 11, including along regions of bends and sharp corners, without causing the patches 10, 110 to buckle of form wrinkles. Accordingly, one or more patches 10, 110 can be used to cover the entire outer circumference of the elongate member 11. The release film 20 can be attached to the adhesive layer 16 to protect the adhesive layer 16 prior to being attached to the elongate member 11, with the release film 20 being selectively removable from the underlying adhesive layer 16 to expose the adhesive layer 16 for adhesion to the bus bar 11.

In accordance with another aspect, a method of constructing a cover 10 for providing flame-resistant, dielectric protection to a bus bar 11 for interconnecting cells of a battery pack B of an electric vehicle EV includes: forming a fabric wall 12 made of flame-resistant material: attaching an impervious layer 14 to an outwardly facing side of the fabric wall 12; and attaching an adhesive layer 16 to an inwardly facing side of the fabric wall 12 such that the fabric wall 12 is sandwiched between the outwardly facing impervious layer 14 and the inwardly facing adhesive layer 16, wherein the adhesive layer 16 is oriented to be fixed to a surface of the bus bar 11.

In accordance with another aspect of the disclosure, the method can further include attaching a release film 20 to the adhesive layer 16 to protect the adhesive layer 16 against damage and contamination when not in use, with the release film 20 being selectively removable from the adhesive layer 16 to expose the adhesive layer 16 for adhesion to the bus bar 11.

In accordance with another aspect of the disclosure, the method can further include providing the impervious layer 14 being one of a silicone, silicone-based, mica-based, liquid silicone rubber, polytetrafluoroethylene, or polyurethane layer.

In accordance with another aspect of the disclosure, the method can further include forming the impervious layer 14 from a liquid or powder mixture coated on the fabric wall 12.

In accordance with another aspect of the disclosure, the method can further include forming the impervious layer 14 from a solid sheet of material, with the solid sheet of material being laminated to the fabric wall 12 via an intermediate adhesive layer 19.

In accordance with another aspect of the disclosure, the method can further include forming the fabric wall 12 by interlacing flame-resistant multifilament yarns together.

In accordance with another aspect of the disclosure, the method can further include providing the flame-resistant multifilament yarn as a mineral yarn.

In accordance with another aspect of the disclosure, the method can further include providing the mineral yarn including at least one of fiberglass yarn, silica yarn, and basalt yarn.

In accordance with another aspect of the disclosure, the method can further include interlacing the flame-resistant multifilament yarn via one of a weaving, braiding and knitting process.

In accordance with another aspect of the disclosure, the method can further include forming the fabric wall 12 in a non-woven process to provide the fabric wall as a non-woven layer.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A cover for protecting a bus bar, comprising:
a fabric wall having made of flame-resistant material;
an impervious layer attached to said fabric wall; and
an adhesive layer attached to said fabric wall, said fabric wall being sandwiched between said impervious layer and said adhesive layer.

2. The cover of claim 1, wherein said fabric wall is fabricated with interlaced flame-resistant multifilament yarn.

3. The cover of claim 2, wherein said flame-resistant multifilament yarn is a mineral yarn.

4. The cover of claim 3, wherein said mineral yarn includes at least one of fiberglass yarn, silica yarn, and basalt yarn.

5. The cover of claim 2, wherein said interlaced yarn is one of a woven, braided and knit structure.

6. The cover of claim 1, wherein said fabric wall is fabricated as a non-woven layer.

7. The cover of claim 1, wherein said impervious layer is one of a silicone layer, silicone-based, liquid silicone rubber layer, mica-based, polytetrafluoroethylene layer, or polyurethane layer, wherein said impervious layer is bonded directly to said fabric wall.

8. The cover of claim 1, wherein said impervious layer is provided as a liquid mixture or a powder mixture, and wherein said impervious layer is coated on said fabric wall.

9. The cover of claim 1, wherein said impervious layer is a solid sheet of material laminated to said fabric wall with an intermediate flame-resistant adhesive layer.

10. The cover of claim 1, wherein said adhesive layer is a self-adhesive layer configured to be exposed for adhesion to the bus bar.

11. The cover of claim 1, wherein said a fabric wall, said impervious layer, and said adhesive layer form a pre-shaped patch configured to be fixedly attached in a conformed fit to the bus bar by adhesion of said adhesive layer to the bus bar.

12. The cover of claim 11, further including a release film attached to said adhesive layer, said release film being selectively removable from said adhesive layer to expose said adhesive layer for adhesion to the bus bar.

13. A cover for protecting a bus bar for forming a connection between cells of a battery of an electric vehicle, consisting of:
a fabric wall having made of flame-resistant material;
an impervious layer attached to said fabric wall; and
an adhesive layer attached to said fabric wall, said fabric wall being sandwiched between said impervious layer and said adhesive layer.

14. The cover of claim 13, wherein said fabric wall is fabricated with interlaced flame-resistant multifilament yarn.

15. The cover of claim 14, wherein said interlaced flame-resistant multifilament yarn is at least one of fiberglass yarn, silica yarn, and basalt yarn.

16. The cover of claim 14, wherein said fabric wall is woven, braided or knit.

17. A method of constructing a cover for providing flame-resistant, dielectric protection to a bus bar for interconnecting cells of a battery of an electric vehicle, comprising:
forming a fabric wall having made of flame-resistant material;
attaching an impervious layer to the fabric wall; and
attaching an adhesive layer to the fabric wall such that the fabric wall is sandwiched between the adhesive layer and the impervious layer.

18. The method of claim 17, further including providing the impervious layer being one of a silicone, silicone-based, liquid silicone rubber, mica-based, polytetrafluoroethylene, or polyurethane layer.

19. The method of claim 17, further including forming the fabric wall by interlacing flame-resistant multifilament yarn via one of a weaving, braiding and knitting process.

20. The method of claim 19, further including providing the flame-resistant multifilament yarn as a mineral yarn including at least one of fiberglass yarn, silica yarn, and basalt yarn.
